(19) United States
(12) Patent Application Publication
(10) Pub. No.: US 2025/0269375 A1
(43) Pub. Date: Aug. 28, 2025

(54) Systems and Methods for Removing Obstructions from Microfluidic Channels

(71) Applicant: Georgia Tech Research Corporation, Atlanta, GA (US)

(72) Inventors: Todd Sulchek, Atlanta, GA (US); Sheng-You Chen, Atlanta, GA (US); Steven Swingle, Atlanta, GA (US)

(21) Appl. No.: 19/063,912

(22) Filed: Feb. 26, 2025

Related U.S. Application Data
(60) Provisional application No. 63/557,730, filed on Feb. 26, 2024.

(51) Int. Cl. B01L 3/00

(52) U.S. Cl. CPC B01L 3/502784; B01L 3/502715; B01L 2200/027; B01L 2200/0673; B01L 2200/14

(57) ABSTRACT

An exemplary embodiment of the present disclosure provides a method comprising a method of removing obstructions from a microfluidic channel. The microfluidic channel can contain a first fluid and at least one obstruction inhibiting flow through the microfluidic channel. The method can comprise flowing at least one fluid droplet of a second fluid through the microfluidic channel to remove the obstruction, wherein the fluid droplet of the second fluid is immiscible with the first fluid in the microfluidic channel.

### CROSS-REFERENCE TO RELATED APPLICATIONS

This application claims the benefit of U.S. Provisional Application Ser. No. 63/557,730, filed on 26 Feb. 2024, which is incorporated herein by reference in its entirety as if fully set forth below.

### GOVERNMENT LICENSE RIGHTS

This invention was made with government support under 1648035 and 2134701, awarded by the National Science Foundation. The government has certain rights in the invention.

### FIELD OF THE DISCLOSURE

The various embodiments of the present disclosure relate generally to systems and methods for removing obstructions, and more particularly for removing obstructions from microfluidic channels using two phase flows.

### BACKGROUND

Obstructions in microfluidic channels are a major hindrance to their performance since they disrupt the precise control of fluid flow and limit processing throughput.

In many applications of microfluidics, biological cells are processed but may aggregate or obstruct the microfluidic flow over time. Cells are particularly difficult particle type to clear due to their adhesiveness and their sensitivity to shear stress, which can rupture membranes and further release cell debris that further increase adhesiveness. Therefore, flowing cells that contact cell debris may adhere and rupture, leading to accelerating aggregation and channel occlusion.

Accordingly, there is a need for improved systems and methods for removing obstructions from microfluidic channels. Embodiments of the present disclosure are directed to this and other considerations.

### BRIEF SUMMARY

An exemplary embodiment of the present disclosure provides a method comprising a method of removing obstructions from a microfluidic channel. The microfluidic channel can contain a first fluid and at least one obstruction inhibiting flow through the microfluidic channel. The method can comprise flowing at least one fluid droplet of a second fluid through the microfluidic channel to remove the obstruction, wherein the fluid droplet of the second fluid is immiscible with the first fluid in the microfluidic channel.

In any of the embodiments disclosed herein, the first fluid can be in a first phase and the at least one fluid droplet of the second fluid can be in a second phase.

In any of the embodiments disclosed herein, the first phase can be a liquid phase and the second phase can be a gaseous phase.

In any of the embodiments disclosed herein, flowing the at least one fluid droplet of the second fluid through the microfluidic channel to remove the obstruction can cause at least a portion of the obstruction to bind to a surface of the fluid droplet.

In any of the embodiments disclosed herein, flowing the at least one fluid droplet of the second fluid through the microfluidic channel to remove the obstruction can comprise injecting the at least one fluid droplet of the second fluid from a second fluid source through an inlet to the microfluidic channel.

In any of the embodiments disclosed herein, the at least one fluid droplet can comprise air.

In any of the embodiments disclosed herein, the obstruction can comprise at least a portion of a biological cell.

In any of the embodiments disclosed herein, the at least one fluid droplet of the second fluid can have a cross-sectional area transverse to a bulk flow direction that is larger than a maximum cross-sectional area transverse to the bulk flow direction of the at least one obstruction.

In any of the embodiments disclosed herein, the at least one fluid droplet of the second fluid can have a cross-sectional area transverse to a bulk flow direction that is larger than a smallest critical dimension of the channel (e.g., to ensure the droplet can come into contact with portions of the channel walls to clear debris).

In any of the embodiments disclosed herein, the method can further comprise, prior to flowing the at least one fluid droplet of the second fluid through the microfluidic channel to remove the obstruction, decreasing a flow rate of the first fluid through the microfluidic channel.

In any of the embodiments disclosed herein, the method can further comprise, after flowing the at least one fluid droplet of the second fluid through the microfluidic channel to remove the obstruction, increasing the flow rate of the first fluid through the microfluidic channel.

Another embodiment of the present disclosure provides a microfluidic system comprising a microfluidic channel, a first inlet in fluid communication with the microfluidic channel, a second inlet in fluid communication with the microfluidic channel, a first fluid source configured to inject a first fluid into the first inlet such that the first fluid flows through the microfluidic channel, and a second fluid source configured to inject at least one fluid droplet of a second fluid into the second inlet such that the at least one fluid droplet flows through the microfluidic channel, wherein the second fluid is immiscible with the first fluid in the microfluidic channel.

In any of the embodiments disclosed herein, the microfluidic system can further comprise a third inlet in fluid communication with the microfluidic channel, and a cell suspension source configured to inject a suspension containing at least one biological cell into the microfluidic channel.

In any of the embodiments disclosed herein, the at least one fluid droplet of the second fluid can be configured to remove an obstruction as it flows through the microfluidic channel.

In any of the embodiments disclosed herein, the second fluid can comprise air.

Another embodiment of the present disclosure provides a method of removing an obstruction from a microfluidic channel. The method can comprise: providing a microfluidic channel having a first fluid flowing therethrough, the microfluidic channel comprising an obstruction, the obstruction comprising at least a portion of a biological cell; and flowing at least one fluid droplet of a second fluid through the microfluidic channel to remove the obstruction, wherein the at least one fluid droplet of the second fluid is immiscible with the first fluid.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a diagram of a microfluidic system, in accordance with some embodiments of the present disclosure.

FIGS. 2A-D provides images of a particle (arrow in FIG. 2A) that became lodged in a microfluidic channel's angled constriction (flow left to right and channel width 560 micrometers), in which cells begin to accumulate and rupture (FIGS. 2C-D), releasing cell debris, around this particle and others out of frame, such that, particle-induced clogging has completely coated the constriction (FIG. 2D at 8 min).

FIGS. 3A-D provides images of a portion of a microfluidic channel in which a large mass containing whole cells and cellular debris (arrow) bound to a multiphase interface and pulled under a 5 micrometers chevron constriction (channel height is 25 micrometers, flow left to right, time between frames (or FIGS. 3A-D) is 0.002 s, channel width 500 micrometers).

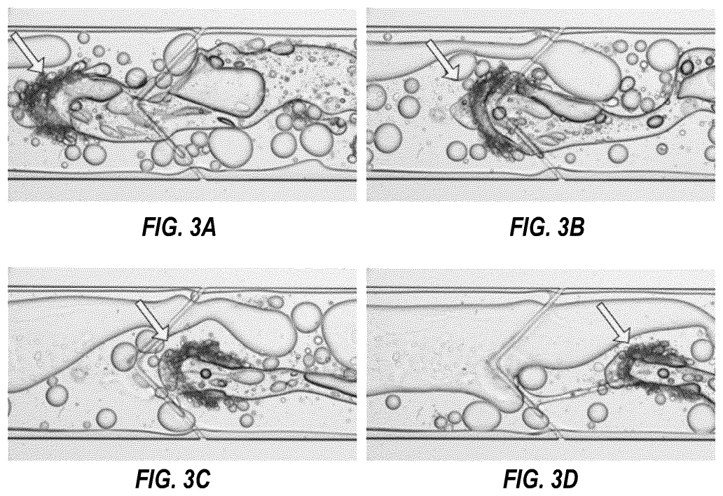

FIGS. 4A-D provide an images illustrating stages of an obstruction-removal process (flow left to right and channel width 560 micrometers), in which at 0 s (FIG. 4A) cell clumps and a large particulate (arrow) are lodged along an angled constriction during normal device operation, at 30 s (FIG. 4B) flowed air bubbles are dislodging obstructions, at 3 min 15 sec (FIG. 4C) the last air bubbles are flowed and normal device operation resumes, and at 8 min 50 s (FIG. 4D) the device remains free of obstructions.

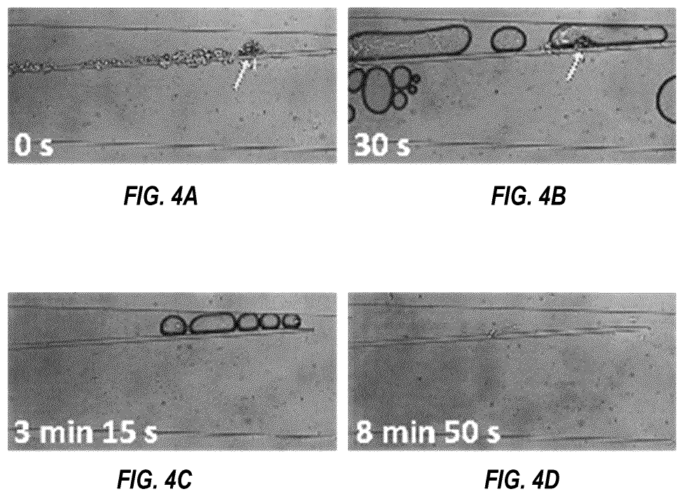

### DETAILED DESCRIPTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

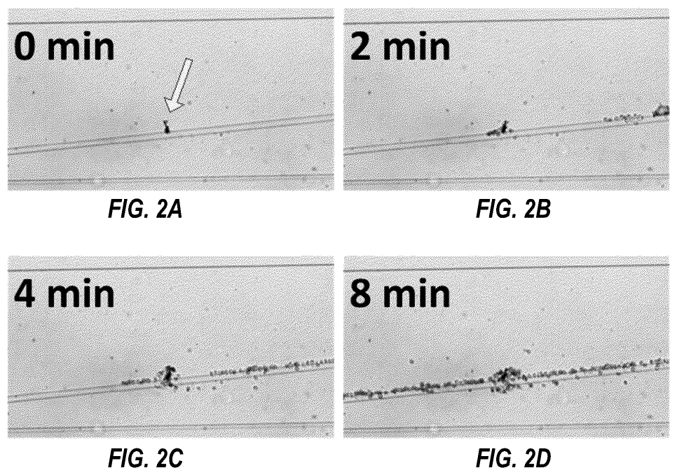

As discussed above, a problem with conventional microfluidic systems comes from an inability to remove debris/particles that ultimately inhibit flow of a fluid through the channel. FIGS. 2A-D provide sequential images of a portion of a microfluidic channel (fluid flow is left to right). As seen by the arrow in FIG. 2A, a particle can become lodged in a portion of a microfluidic channel, e.g., the angled construction shown in the figure. Over time, as shown in FIGS. 2B-D, additional debris can build up, inducing clogging in the channel. The clogging can occur when fluid drag forces of the primary fluid flowing through the microchannel (e.g., a buffer solution) are insufficient to overcome forces resisting particle motion, which can include contact forces between the particles and the channel including friction, adhesion, and normal forces, and other forces such as buoyancy or electromagnetic forces.

The present disclosure provides systems and methods for clearing debris/obstructions, e.g., cells and/or portions thereof, in microfluidic channels by flowing non-miscible fluid droplets through obstructed microfluidic channels. Interfacial tension and other forces associated with two-phase flow can create conditions to clear channel obstructions. At the microscale, flown droplets can include air, oil, water, or any other fluid not miscible with the continuous fluid phase. The droplet interface can create strong forces (e.g., binding affinity between droplets and particle obstructions) that act on particle obstructions. Droplets and bubbles flowing through a microfluidic channel can therefore be used to dislodge particles that are adhered to the channel surface. There can be significant improvement to clearance than that achieved by equivalent flow of a uniform liquid. Additionally, the high interfacial force surrounding the droplet can trap particles in the moving interface thus dislodging the particle and carrying it away. This interfacial force generated by the two-phase flow can be especially effective at attracting and carrying away cell debris including lodged whole cells and associated DNA from fragmented cells.

For example, when the obstruction particles and fluid droplets make contact, hydrodynamic forces acting on the droplets can transmit to the particle. Droplet forces can be characterized as compressive or tensile. Compressive forces are derived from internal droplet pressure which pushes on particles via the contact of the droplet interface and the particle. This can occur whenever the droplet is deformed out of its equilibrium shape around the particle due to the hydrodynamic forces acting on the droplet. Tensile forces are derived from forces associated with the binding of particles to the droplet interface, a well-known phenomenon. These forces will pull on particles whenever the portion of the droplet interface that is adhered to the particle is deformed out of its equilibrium shape due to the hydrodynamic forces acting on the droplet.

When droplets and obstructing particles come into contact, the drag force acting on the droplet can transmit to the particle by means of the forces discussed above. When the droplet's cross-sectional area (CSA) perpendicular (i.e., transverse) to the flow direction is larger than that of the particle, the forces acting on the particle by the droplet are higher than the form drag force on the particle alone. This is because the droplet effectively “adds” to particle's CSA, thus increasing the drag force acting on the particle. This effective increase in drag can sufficiently overcome the forces keeping the particle stagnant, thus dislodging the particle. Additionally, through the use of multiple droplets to dislodge particles, one (or more) droplet(s) can “push” on the particle simultaneously while one (or more) other droplet(s) “pull” on the particle.

To better ensure that all drag forces acting on the droplet are transmitted to the particle, it can be desirable to ensure that (1) the surface tension of the droplet's fluid-fluid interface is sufficient so that the droplet does not split, and (2) the adhesion between the droplet's fluid-fluid interface and the particle is sufficient so that binding can withstand the tensile forces between the droplet and particle.

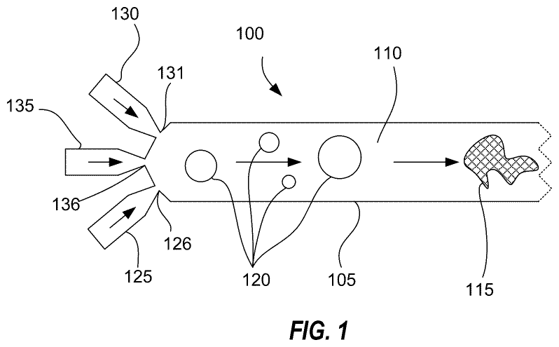

FIG. 1 provides a microfluidic system 100 capable of removing obstructions, in accordance with some embodiments of the present disclosure. The system can comprise a microfluidic channel 105 through which a first fluid 110 generally flows (bulk flow direction is left to right as indicated by the arrows in FIG. 1). The first fluid broadly encompasses any fluid for facilitating flow through the channel, and can include, but is not limited to, water, saline solution, phosphate-buffered saline solutions, and the like. Though only a single microchannel 105 is shown in FIG. 1, as those skilled in the art would appreciate, multiple microchannels are also contemplated by the present disclosure. FIG. 1 further depicts an obstruction 115 in the microchannel 105 inhibiting flow therethrough. As those skilled in the art would appreciate, the obstruction can have a range of effects from slowing or completely blocking flow of the buffer solution. The obstruction can occur through debris/particles flowing through the microfluidic channel, such as biological cells, or portions of cells due to cell rupturing. The system 100 can be configured to allow for fluid droplets 120 of a second fluid to flow through the channel. As discussed above, the fluid droplets 120 of the second fluid can engage the obstruction 115 (or one or more particles thereof) and remove it from the channel.

The second fluid can be many fluids known in the art. In particular, the second fluid can be immiscible with the first fluid 110, such that the fluid droplets 120 of the second fluid can remain separated from the first fluid 110 as they flow through the channel 105. In some embodiments, the fluid droplets 120 of the second fluid can be in a different phase than the buffer solution 110. For example, the first fluid 110 can be in a liquid phase, while the fluid droplets 120 of the second fluid can be in a gaseous phase, though disclosure is not so limited. Exemplary second fluids can include, but are not limited to, air, oil, water, solutions of dissolved molecules in a fluid solvent, and the like.

The system 100 can further comprise one or more material sources, including but not limited to a first fluid source 130, cell suspension source 135, and second fluid source 125, for holding the respective materials prior to injection into the channel 105. The cell suspension source 135 can comprise one or more biological cells suspended in growth media. Each material source 125, 130, 135 can have a corresponding inlet 126, 131, 136 for placing the sources 125, 130, 135 in fluid communication with the channel 105. Though the embodiment shown in FIG. 1 includes three sources 125, 130, 135, the disclosure is not so limited. As those skilled in the art would appreciate, more or less sources can be included in the system. For example, in some embodiments, the first fluid and cell suspension can be injected into the channel from the same source.

In some embodiments, though not shown in FIG. 1, the second fluid source 125 can be positioned proximate the first fluid source 130. The fluid droplets 120 can be injected from the second fluid source 125 and into the first fluid source 130, such that the first fluid 110 can contain the fluid droplets 120 in the first fluid source 130 and the first fluid 110 and second fluid droplets 120 are injected together from the first fluid source 130 into the channel 105. In such embodiments, the second fluid source can be configured as a removable “module” that can be connected upstream of the first fluid inlet 131 when debris removal is needed. In some embodiments, the second fluid source 125 can be a removable module that can be connected to the second fluid inlet 126 when debris removal is needed.

Though not shown in FIG. 1, in some embodiments, the system 100 can further include means for controlling the rate of flow of the various materials (e.g., first fluid, cell suspension, second fluid) into the channel 105. The means can include any such means known in the art, including but not limited to, variable speed pumps, constriction dampers, pressure regulators/alternators, and the like. For example, in some embodiments, the second fluid source 125 and/or inlet 126 can include geometrical features such as constrictions or grooves that keep the second fluid stationary on standby at the end of the inlet 126 for a range of channel pressures while the second fluid is not being injected into the channel 105.

In some embodiments, the system can include mechanisms that alter physical properties of droplets to make them easier to handle, control, or remove, including but not limited to: features to merge droplets together such as electric-field-induced interface instability or rapid channel width expansion; features such as sharp channel obstructions, channel narrowing, or crossflow meant to split larger fluid droplets into smaller ones; and/or strategies to weaken or enhance the interfacial tension surrounding the fluid droplets including chemical modifications such as use of surfactants or hydrophobic/hydrophilic chemical treatment of channel surfaces.

Additionally, in some embodiments, the second source 125 and/or inlet 126 can be configured to control an average size of the fluid droplets 120 injected into the channel. This can be done many ways known in the art, including, but not limited to, controlling/setting/adjusting an inlet cross-sectional area, a pressure of the second fluid, and/or a flow rate of the fluid droplets 120. For example, in some embodiments, it may be desirable to control a diameter of the fluid droplets relative to a cross-sectional area of the microfluidic channel 105. For example, in some embodiments, it can be desirable to ensure the fluid droplets 120 have a size sufficient to remove the obstruction. Such a size can include an average fluid droplet diameter that is at least 1X, 2X, 5X, or 10X (where X is an average diameter of the obstruction 115). Additionally, in some embodiments, the size of the average fluid droplet diameter can be greater than an average diameter of a cross section of the channel 105 in the bulk flow direction.

In some embodiments, it may be desirable to control one or more other properties of the fluid droplets 120 injected and flowing through the channel 105. These properties can include, but are not limited to, size, surface tension, binding affinity, contact angles with the channel and/or debris, quantity, surface chemistry, rheology, density, and the like.

Though not shown in FIG. 1, in some embodiments, the system 100 can further include one or more outlets for ejecting the second fluid and obstructions from the channel 105. For example, the system 100 can include a first outlet used to eject the second fluid and obstructions when the second fluid is injected into the channel 105 and a second outlet that is utilized in normal operation to eject the first fluid and cell suspensions from the channel. In some embodiments, the system can include a bubble trap or other phase separating mechanism for separating the second fluid from other fluids (e.g., first fluid and/or cell suspension).

In some embodiments, the system 100 can include any geometrical features in the microfluidic channel 105 such as gutters, angled ridges, or channel bifurcations that direct the various fluids (e.g., first fluid, second fluid, and/or cell suspension) towards a desired path.

Though also not shown in FIG. 1, in some embodiments, the system 100 can include one or more valves to control flow through the various inlets and/or outlets.

In addition to microfluidic systems, the present disclosure also provides methods of removing obstructions from a microfluidic channel. As discussed above, a microfluidic channel can contain a first fluid flowing therethrough, in which one or more obstructions, e.g., cells or portions thereof, can inhibit flow of the first fluid and cells contained therein. Accordingly, the present disclosure provides a method of removing the obstruction. The method can comprise flowing at least one fluid droplet of a second fluid through the microfluidic channel to remove the obstruction, wherein the fluid droplet of the second fluid is immiscible with the first fluid in the microfluidic channel.

As also discussed above, the first fluid can be in a different phase (e.g., state of matter, e.g., liquid v. gas) than the fluid droplet(s) of the second fluid. For example, the buffer solution can be in a liquid phase and the fluid droplets of the second fluid can be in a gaseous phase.

In some embodiments, as discussed above, as the fluid droplet(s) flows through the channel, the at least a portion of the obstruction can bind to a surface of the fluid droplet, thereby removing the obstruction as the fluid droplet continues to flow through the channel.

As discussed above, the fluid droplet(s) can be injected from a second fluid source via an inlet. In some embodiments, the fluid droplet(s) can be injected while the first fluid is still flowing through the channel. In some embodiments, however, prior to flowing the fluid droplet(s) of the second fluid through the microfluidic channel to remove the obstruction, the flow rates of the first fluid can be decreased (or stopped). After flowing the fluid droplet(s) of the second fluid through the microfluidic channel to remove the obstruction, the flow rate of the first fluid through the microfluidic channel can be increased again, e.g., back to the original flow rate. For example, as flow is halted through the cell inlet due to an obstruction present downstream in the channel, pressure can be increased in the second fluid (e.g., air) inlet until the fluid droplets begin to flow through the channel. The fluid droplets (e.g., air bubbles) can be flown continuously in parallel with the first fluid until the cell obstructions in the channel are sufficiently cleared. Then, airflow can be stopped and time allowed for air bubbles and trapped debris to clear out of the channel. The first fluid flowrate can be increased if necessary. After bubbles are cleared, the flowrates can return to their normal state.

The present disclosure can also be used in genetic applications for microfluidics. There, clearing obstructing debris with the disclosed systems/methods may restore flow patterns through the microfluidic channel that are critical to achieving desired outcomes. For devices in which cells are pre-processed for single-cell-sequencing, microfluidic cell isolation mechanisms may be obstructed by whole cells or cell debris. For devices in which cells are flown through constrictions smaller than cell diameters to induce mechanoporation for the purpose of gene transfection, constrictions may be obstructed in manners which reduce gene uptake in cells. Through implementation of the disclosed mechanism (e.g., adding an inlet upstream of the obstructing debris in which droplets consisting of a non-miscible fluid phase can be introduced) droplets may dislodge and transport the whole cells debris out of the channel and restore device function.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A method of removing obstructions from a microfluidic channel, the microfluidic channel containing a first fluid and at least one obstruction inhibiting flow through the microfluidic channel, the method comprising:
flowing at least one fluid droplet of a second fluid through the microfluidic channel to remove the obstruction, wherein the fluid droplet is immiscible with the first fluid in the microfluidic channel.

2. The method of claim 1, wherein the first fluid is in a first phase and at least one fluid droplet of the second fluid is in a second phase.

3. The method of claim 1, wherein the first phase is a liquid phase and the second phase is a gaseous phase.

4. The method of claim 1, wherein flowing at least one fluid droplet through the microfluidic channel to remove the obstruction causes at least a portion of the obstruction to bind to a surface of the fluid droplet.

5. The method of claim 1, wherein flowing the at least one fluid droplet through the microfluidic channel to remove the obstruction comprises injecting the at least one fluid droplet from a fluid source through an inlet to the microfluidic channel.

6. The method of claim 1, wherein the second fluid comprises air.

7. The method of claim 1, wherein the obstruction comprises at least a portion of a biological cell.

8. The method of claim 1, wherein the at least one fluid droplet has a cross-sectional area transverse to a bulk flow direction that is larger than a maximum cross-sectional area transverse to the bulk flow direction of the at least one obstruction.

9. The method of claim 1, further comprising, prior to flowing the at least one fluid droplet of the second fluid through the microfluidic channel to remove the obstruction, decreasing a flow rate of the first fluid through the microfluidic channel.

10. The method of claim 9, further comprising, after flowing the at least one fluid droplet of the second fluid through the microfluidic channel to remove the obstruction, increasing the flow rate of the first fluid through the microfluidic channel.

11. The method of claim 1, wherein the second fluid further comprises a compound configured to increase a binding affinity between the at least one fluid droplet and the at least one obstruction.

12. A microfluidic system, comprising:
a microfluidic channel;
a first inlet in fluid communication with the microfluidic channel;
a second inlet in fluid communication with the microfluidic channel;
a first fluid source configured to inject a first fluid into the first inlet such that the first fluid flows through the microfluidic channel; and
an obstruction removal fluid source configured to inject at least one fluid droplet of a second fluid into the second inlet such that the at least one fluid droplet flows through the microfluidic channel, wherein the second fluid is immiscible with the first fluid in the microfluidic channel.

13. The microfluidic system of claim 12, further comprising:
a third inlet in fluid communication with the microfluidic channel; and
a cell suspension source configured to inject a suspension containing at least one biological cell into the microfluidic channel.

14. The microfluidic system of claim 12, wherein the first fluid is in a first phase and the fluid droplet of the second fluid is in a second phase.

15. The microfluidic system of claim 14, wherein the first phase is a liquid phase and the second phase is a gaseous phase.

16. The microfluidic system of claim 12, wherein the at least one fluid droplet of the second fluid is configured to remove an obstruction as it flows through the microfluidic channel.

17. The microfluidic system of claim 16, wherein the obstruction comprises at least a portion of a biological cell.

18. The microfluidic system of claim 12, wherein the second fluid comprises air.

19. A method of removing an obstruction from a microfluidic channel, the method comprising:
providing a microfluidic channel having a first fluid flowing therethrough, the microfluidic channel comprising an obstruction, the obstruction comprising at least a portion of a biological cell; and
flowing at least one fluid droplet of a second fluid through the microfluidic channel to remove the obstruction, wherein the at least one fluid droplet of the second fluid is immiscible with the first fluid.

20. The method of claim 19, wherein the first fluid is in a first phase and the at least one fluid droplet of the second fluid is in a second phase.
